(19) United States
(12) Patent Application Publication
(10) Pub. No.: US 2019/0163595 A1
(43) Pub. Date: May 30, 2019

(54) SYSTEM AND METHOD FOR PROVIDING NETWORK ACCESS IN THE EVENT OF A COMPUTER SYSTEM FAILURE

(71) Applicant: Rustin B. PENLAND, Nederland, TX (US)

(72) Inventor: Rustin B. PENLAND, Nederland, TX (US)

(21) Appl. No.: 16/197,313

(22) Filed: Nov. 20, 2018

Related U.S. Application Data
(60) Provisional application No. 62/592,537, filed on Nov. 30, 2017.

(51) Int. Cl. G06F 11/22; G06F 11/14; G06F 11/07

(52) U.S. Cl. CPC G06F 11/2284; G06F 2011/2278; G06F 11/0793; G06F 11/1417

(57) ABSTRACT

The present invention is directed to a computer system and method involving a microchip configured to provide network access. In particular, the microchip is configured to provide network access when a computer system experiences a failure that prevents the computer system from initializing a network interface or loading an operating system that allows a computer user to access Internet. The microchip includes a non-volatile memory storing a computer program that is different from BIOS. The microchip is configured to initialize a network interface and connect the computer system to a communications network provided by the network interface without loading an operating system. The failure may occur in a boot process or other process in a start-up procedure. The microchip may be configured to perform the initialization and connection when the failure occurs in any process of the start-up procedure.

This application claims the benefit of U.S. application Ser. No. 62/592,537 filed Nov. 30, 2017, the entire content of which is expressly incorporated herein by reference thereto.

### FIELD OF THE INVENTION

The present invention relates to computer systems, and more particularly, to a system and method involving a microchip configured to provide network access in the event of a computer system failure that prevents user access to an operating system.

### BACKGROUND OF THE INVENTION

Many companies and individual users depend on computers to meet their information processing needs. Although functionality and reliability of computers have improved significantly in recent years, computers can still experience an issue once in a while. The issue may be software or hardware-related. Computers may freeze or hang due to virus or incorrect operating system configuration. Computers may not be able to start because a peripheral of the computer, such as a hard drive, does not function properly. In any of these situations, there is a high chance that the users cannot access the operating system and the computer becomes unusable.

Computers are generally equipped with some form of internal diagnostics to help recover from a computer issue. An internal diagnostic software system may include a graphical user interface that guides the users through the technically complex execution of diagnostic routines. To ease the process, the interface is designed to be aesthetically pleasing and user-friendly. Inexperienced users, however, are still forced to interact with the technical diagnostic instructions, report findings to a remote technician via telephone if the users decide to consult a remote technician, and/or take actions under direction of the remote technician over telephone. These procedures are time consuming, laborious, and expensive.

There are a few possible solutions to the aforementioned problem. First, the technician can travel to the site of the troubled computer to directly repair the computer. This is, however, a great waste of the technician's time and frequently removes the technician from technical resources, such as repair manuals and tools, that are available at the technical support center. Second, the troubled computer can be removed from its location and be delivered to a computer repair facility. This is, however, impractical for large businesses that have hundreds or thousands of computers. Third, the remote technician can perform remote diagnostics via communications software that runs under the computer's operating system and that relies on Internet. Unfortunately, this option is only available when the computer is substantially operable. Fourth, computers can be supplied with dedicated diagnostic hardware. This is, however, not only expensive, rendering computers noncompetitive in terms of price, but is also a wasteful duplication of hardware, as the diagnostic hardware comes into use only rarely.

Accordingly, there remains a need for a computer system and computer method for providing network access in the event of a computer failure that are improved over what is currently known in the art and that eliminate the shortcomings of the solutions mentioned above.

### SUMMARY OF THE INVENTION

In accordance with principles of the present invention, a computer system for providing network access during a computer system failure of the computer system is contemplated. In one embodiment, the system may comprise a first processor and a first non-volatile memory electrically connected to the first processor. The first non-volatile memory stores a first firmware that is readable and executable by the first processor and that is implemented to perform a boot process. The system may also comprise a network interface configured to interface with a communications network and to be off prior to loading an operating system. The system may further comprise a microchip electrically connected to the first processor. The microchip includes a second non-volatile memory storing a second computer program that is readable and executable by the first processor. The second computer program is implemented to initialize the network interface and connect the computer system to the communications network via the network interface when the first processor detects a failure in the boot process.

In an alternative embodiment, the first processor may read and execute the first firmware to perform the boot process that includes initializing and testing additional electronic components and loading an operating system. The first processor may be configured to detect that one of the additional electronic components is experiencing a failure in the initializing and testing step. The first processor may be configured to read and execute the second computer program when the failure in the initializing and testing step is detected. The network interface may be initialized and connect the computer system to a communications network upon execution of the second computer program.

In an alternative embodiment, the first processor may be configured to detect a failure in loading an operating system. The first processor may be configured to read and execute the second computer program when the failure in loading an operating system is detected. The network interface may be initialized and connect the computer system to a communications network upon execution of the second computer program.

In an alternative embodiment, the second computer program may include a graphical user interface having a command allowing a computer user to communicate with a computer technician in a remote location via the communications network. The graphical user interface may also include a command allowing a computer user to share screen or transfer data via the communications network.

In an alternative embodiment, the first processor may read and execute the first firmware to perform the boot process that is part of a start-up procedure. The start-up procedure may further include a power-up process and a preliminary activation process. The microchip may further include a second processor. The second processor may be configured to detect a power supply failure in the power-up process. The second processor may be configured to read and execute the second computer program when the power supply failure is detected.

In an alternative embodiment, the second processor may be configured to detect an electronic component failure in the preliminary activation process. The second processor may be configured to read and execute the second computer program when the electronic component failure is detected.

In an alternative embodiment, the failure is a hard drive failure or a software failure.

In an alternative embodiment, the network interface is an Ethernet adapter, a wireless network adapter, or a Bluetooth adapter.

In accordance with principles of the present invention, a method for providing network access during a computer system failure is contemplated. In one embodiment, the method may comprise performing, by a first processor reading and executing a first firmware in a first non-volatile memory, a boot process. The method may also comprise configuring a network interface capable of interfacing with a communications network to be off prior to loading an operating system. The method may further comprise initializing, by the first processor reading and executing a second computer program in a second non-volatile memory, the network interface and connecting, by the initialized network interface, the computer system to the communications network when the first processor detects a failure in the boot process.

### BRIEF DESCRIPTION OF THE DRAWINGS

FIG. 1 depicts an illustrative computer system comprising a microchip in accordance with some embodiments of the present invention;

FIG. 2 depicts an illustrative microchip in accordance with some embodiments of the present invention;

FIG. 3 depicts a plurality of illustrative electronic components that a microchip can be configured to communicate with by default in accordance with some embodiments of the present invention;

FIG. 4 depicts an illustrative start-up procedure carried out by a computer system having a microchip in accordance with some embodiments of the present invention; and

FIG. 5 depicts an illustrative graphical user interface provided by the second computer program in accordance with some embodiments of the present invention.

### DETAILED DESCRIPTION OF THE INVENTION

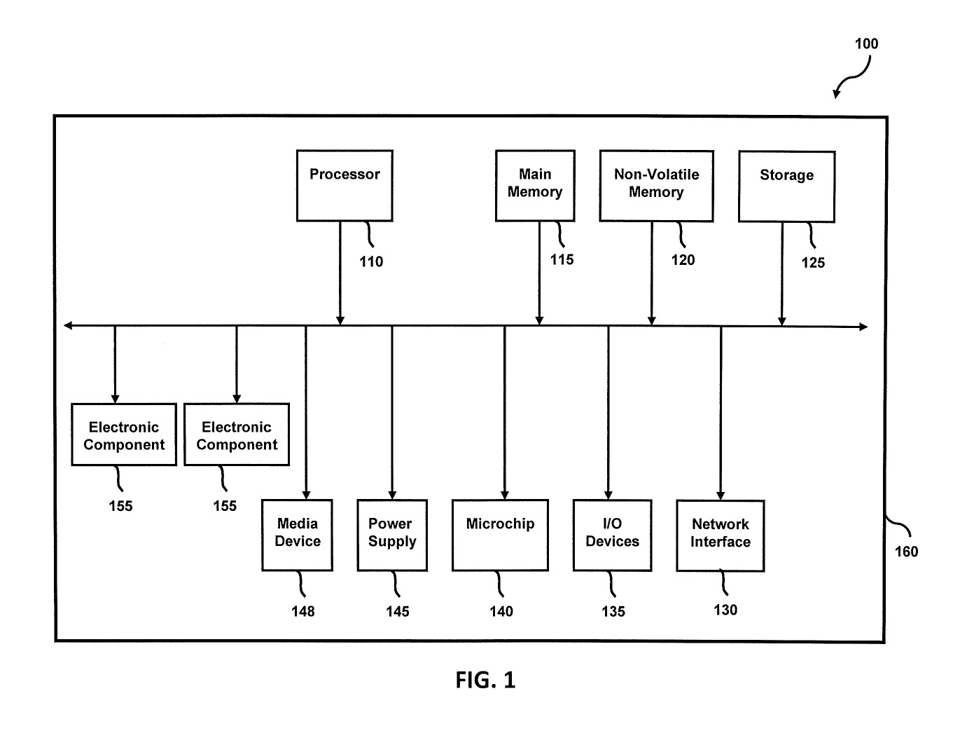

FIG. 1 depicts an illustrative computer system 100 comprising a microchip 140 in accordance with some embodiments of the present invention. The computer system 100 includes a processor 110, main memory 115, non-volatile memory 120, a storage 125, a network interface 130, input/output (I/O) devices 135, a microchip 140, a power supply 145, a media device 148, and one or more communications buses 150 communicatively or electrically couple the above-described components together. The computer system 100 can include additional electronic components 155. The computer system 100 includes a motherboard or a printed circuit board 160 on which all these electronic components are mounted.

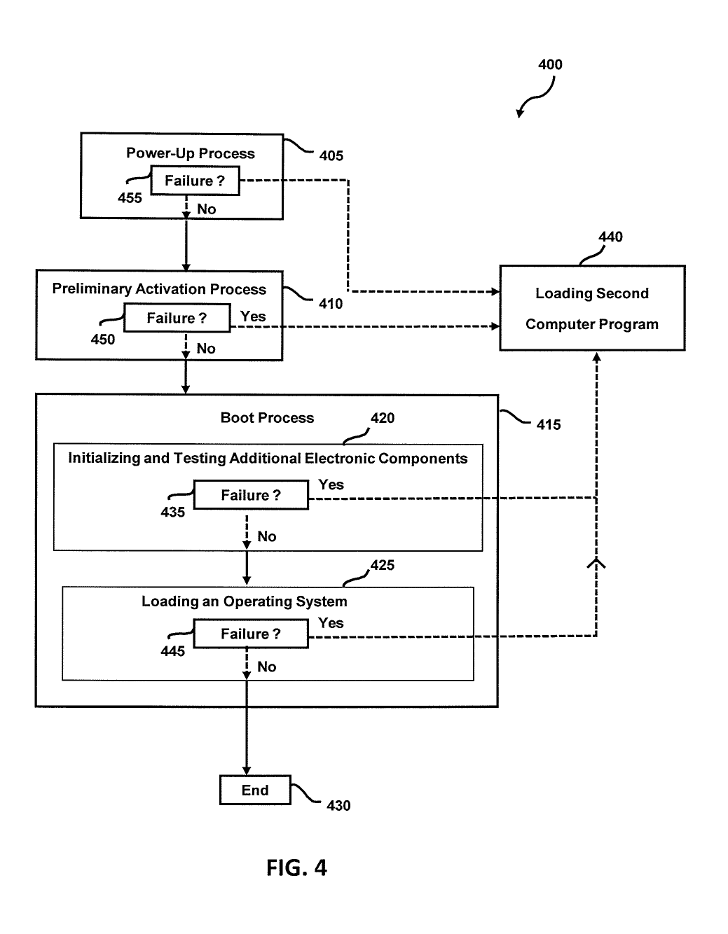

The processor 110 can include a central processing unit (CPU), a graphics processing unit (GPU), a microprocessor (μP), an application specific integrated circuit (ASIC), a programmable logic array (PLA), a digital signal processor (DSP), a field programmable gate array (FPGA), a reduced instruction set computing (RISC) processor, or other types of processors. The processor 110 controls the operations and performance of the computer system 100. The processor 110 can read and execute computer instructions that are stored on memory 115, 120. Main memory 115 can include random-access memory (RAM), cache memory, or other types of memory used for temporarily storing data. The non-volatile memory 120 and the storage 125 can include read-only memory (ROM), erasable programmable read-only memory (EPROM), flash memory, solid state memory, ferroelectric RAM (FRAM), magnetoresisitve RAM (MRAM), hard disk drive, solid state drive, floppy disk, magnetic tape, optical disc, or other types of memory and storage used for permanently storing data. The non-volatile memory 120 and the storage 125 can be the same device. The non-volatile memory 120 is configured to store Basic Input/Output System (BIOS) or other similar firmware used to perform a number of tasks, including a boot process. A boot process includes initializing and testing of various hardware devices implemented within the computer system 100 and performing other associated steps. An illustrative boot process is described with respect to FIG. 4 below. BIOS may include a diagnostic application. BIOS is pre-stored or pre-installed in the computer system 100 prior to deployment to a computer user. The storage 125 is configured to store an operating system such as Windows, Android, macOS, iOS, Linux, or other types of operation system. In operation, BIOS is executed by the processor 110 before the processor 110 executes the operating system, or is the first program executed by the processor 110 after the computer system 100 is powered on. The operating system is loaded by the processor 110 during or at the end of the boot process. BIOS and the operating system can also be stored on the non-volatile memory 120 and the storage 125, respectively, or on both the non-volatile memory 120 and the storage 125 (e.g., part of the system is stored on the storage and part of the system is stored on the non-volatile memory). The non-volatile memory 120 may also be configured to receive and store instructions and data modifying or updating BIOS only. In this situation, the non-volatile memory 120 is configured to prevent the computer user from saving data obtained through the operating system (e.g., data or a document created using the operating system or data or a document downloaded from Internet using the operating system) to the non-volatile memory 120. The storage 125 is configured to allow the computer user storing data obtained through the operating system.

The network interface 130 is configured to exchange data with an access point, a server, another computer system, or other devices via a communications network. The network interface 130 is operative to interface with a communications network using any suitable communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOW, or any other suitable protocol. The network interface 130 can include an Ethernet adapter (for wired connection), a wireless network adapter, a Bluetooth adapter, or other similar types of adapters. The communications network may also be established by using wires such as an optical fiber or Ethernet cable. The I/O devices 135 can include a display (e.g., CRT display, plasma display, LED display, LCD display, etc.) for displaying information and a speaker for outputting audio to a computer user, and an input device (e.g., keyboard, mouse, trackball, cursor direction keys, microphone, etc.) for communicating information and command selections to the processor 110. The I/O devices 135 can also include circuitry that converts and encodes/decodes analog signals and other signals into digital data. In some embodiments, I/O devices 135 can also convert digital data into another type of signal, and vice-versa. For example, I/O devices 135 can receive and convert physical contact inputs from a multi-touch screen, physical movements from a mouse or sensor, analog audio signals from a microphone, or other input. The digital data can be provided to and received from components of the computer system 100.

The power supply 145 may be one that relies on an electrical outlet to supply electric energy to the computer system 100 and its hardware components. For example, the power supply 145 may be a DC power supply, AC power supply, switched-mode power supply, programmable power supply, uninterruptible power supply, high voltage power supply, or other similar power supplies. The power supply 145 may also be a battery. The media device 148 may be a read-only optical memory device (e.g., CD-ROM, DVD-ROM, etc.), a flash card reader, a USB port, or the like. The bus 150 can include a memory bus or memory controller, a peripheral bus, a serial bus, an accelerated graphics port, a process or local bus using any of a variety bus architectures and similar and complementary devices. The additional electronic components 155 can include a video card, a sound card, a printer, and other devices.

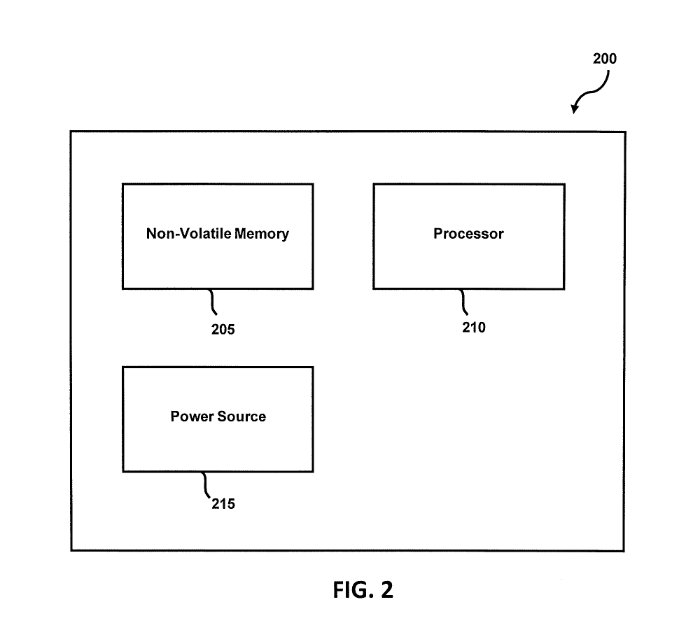

The microchip 140 is an integrated circuit that includes one or more electronic devices. FIG. 2 depicts an illustrative microchip 200 in accordance with some embodiments of the present invention. The microchip 200 includes a non-volatile memory 205. The non-volatile memory 205 can include read-only memory (ROM), flash memory, solid state memory, ferroelectric RAM (FRAM), magnetoresisitve RAM (MRAM), hard disk drive, solid state drive, floppy disk, magnetic tape, optical disc, or other types of memory used for permanently storing data. The non-volatile memory 205 is configured to store a second computer program that is different from BIOS or the first firmware stored in the non-volatile memory 120 (FIG. 1). The second computer program is readable and executable by the processor 110 (FIG. 1). The second computer program may be a firmware, an operating system, or other computer software. The non-volatile memory 205 is configured to communicate with the processor 110 so the processor 110 can read and execute the second computer program. The non-volatile memory 205 may also be configured to store the second computer program and to receive and store instructions and data modifying or updating the second computer program only. In this situation, the non-volatile memory 205 is configured to prevent the computer user from saving data obtained through the operating system (e.g., data or a document created using the operating system or data or a document downloaded from Internet using the operating system) to the non-volatile memory 205. The second computer program may include a diagnostic application. The second computer program is pre-stored or pre-installed in the computer system 100 prior to deployment to a computer user. The second computer program may readable and executable by the processor 110.

The microchip can also include a processor 210 that is configured to read and execute the second computer program. The processor 210 may be configured to read and execute the second computer program only or configured without reading or executing any other computer programs or instructions stored in an electronic component external to the microchip 200. In some embodiments, the processor 210 can be configured to read and execute other computer programs or instructions stored in an electronic component external to the microchip 200, such as an operating system. The processor 210 can include any processor described above. The microchip 200 can also include a power source 215 that is configured to provide electric energy to the microchip 200 and/or other electronic components in the computer system 100. The power source 215 may be configured to provide electric energy when the power supply 145 (FIG. 1) fails to operate or when the power cord for connecting an electrical outlet and the computer system is damaged. In some embodiments, the power source 215 may be configured to provide electric energy even when the power supply 145 is functioning or when the power cord is unscathed. Preferably, the power source 215 is a battery, but it can also include a power supply as described above or other types of power source. The microchip 200 may further include a main memory and a storage such as those described above. At the minimum, the microchip 200 contains the non-volatile memory 205 (with the second computer program stored thereon).

Referring back to FIG. 1, although that figure shows the microchip 140 as a device separate and distinct from the processor 110 (e.g., has its own dedicated connection to the bus), in some embodiments the microchip 140 can be implemented in the processor 110 or other electronic component in the computer system 100 (e.g., sharing a connection to the bus). When the microchip is a separate and distinct device, the motherboard 160 includes an electrical socket configured to receive the microchip. The microchip may be fixed to the motherboard 160 such that it is incapable of being removed from the motherboard. The microchip may be pre-mounted on (e.g., embedded into or integrated with) the motherboard 160 during the manufacturing process of the motherboard or subsequently mounted on the motherboard 160 after the manufacturing process of the motherboard (e.g., installed by the user). The microchip may be removable after it is mounted. In some embodiments, the microchip 140 may be a portable device that can be plugged into a computer system (via a serial port, parallel port, or other types of communications port that is different from the electrical socket) that does not have a microchip. As such, the microchip 140 can function as a plug-and-play device and be plugged into and removed from the computer system as the user wishes.

The electrical socket is connected to the bus 150. The electrical socket (or the microchip) may be based on surface-mount technology such as ball grid array (BGA), land grid array (LGA), pin or lead-based connection (e.g., dual inline package (DIP), small outline integrated circuit package (SOIC), small outline package (SOP), quad flat package (QFP), etc), pin or leadless connection (e.g., quad flat no-leads package (QFN)), or other types of surface-mount technology. The electrical socket may also be a serial port configured to provide serial communication (e.g., universal serial bus port, Firewire port, serial ATA port, serial SCSI port) or a parallel port (e.g., parallel ATA port, IEEE-1284 port, IEEE-488 port) configured to provide parallel communication. The electrical socket may also be based on Peripheral Component Interconnect (PCI) or PCI Express (PCIe). Other types of electrical socket are also contemplated.

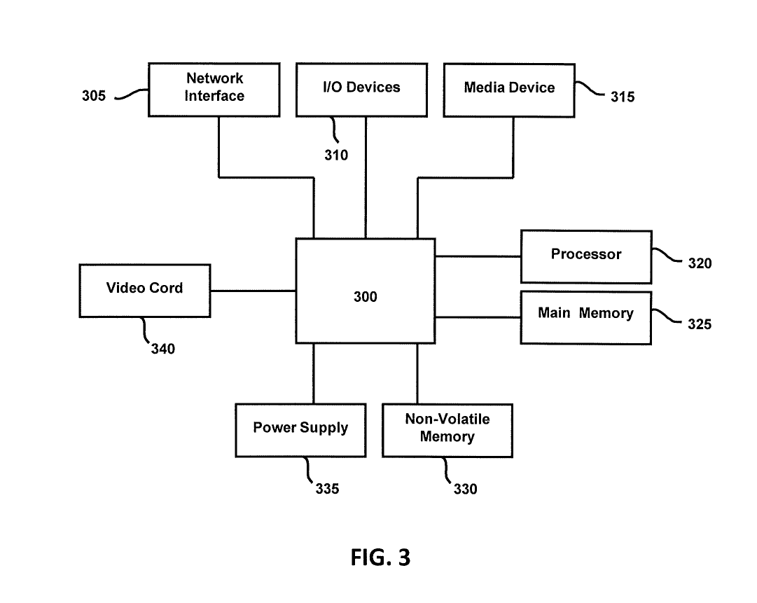

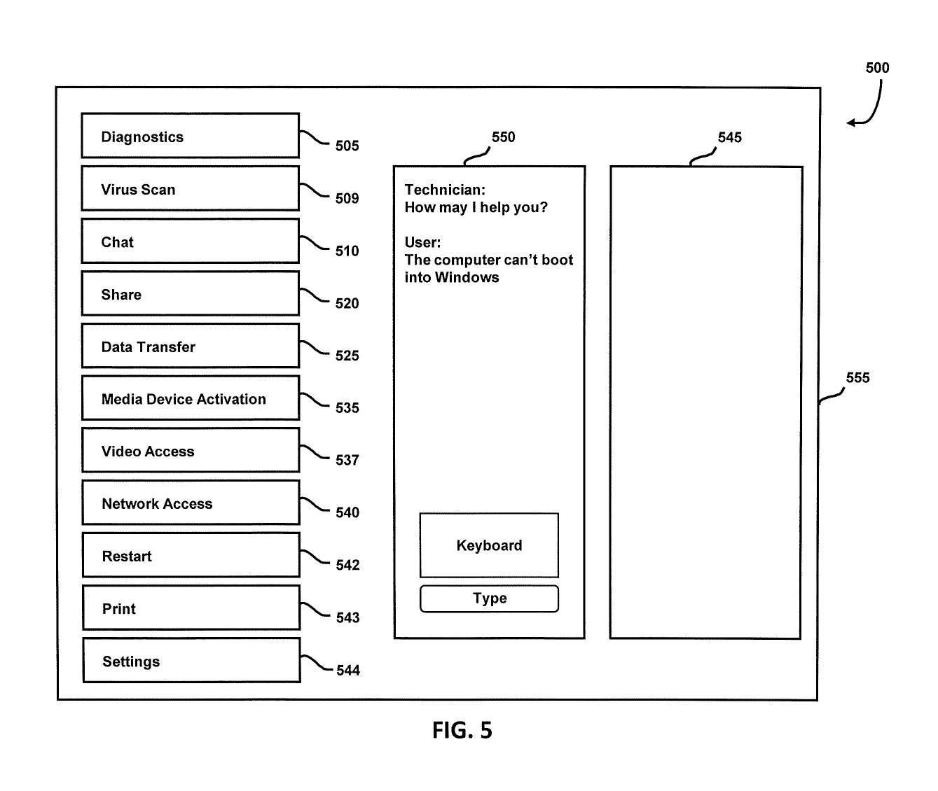

The microchip may be configured to communicate with one or more electronic components within the computer system 100 via the bus 150 by default (determined by the microchip without user selection). The microchip has direct access to the one or more electronic components allowing the microchip to access the one or more electronic components without relying on BIOS or the operating system. The microchip is preferably configured to communicate with the network interface 130, the I/O devices 135, and the media device 148 by default, or at least with these devices by default. The microchip may be further configured to communicate with a video card and a sound card since they may be required in order to output images and sound. FIG. 3 depicts a plurality of illustrative electronic components that a microchip 300 can be configured to communicate with by default in accordance with some embodiments of the present invention. The plurality of electronic components may include a network interface 305, I/O devices 310, a media device 315, a processor 320, main memory 325, non-volatile memory 330 (memory on which BIOS is installed), a power supply 335, and a video card 340. The microchip may be configured to communicate with additional electronic components, and the configuration may depend on whether the microchip further includes a processor, a power source, a main memory, and/or a storage, in addition to the non-volatile memory. The microchip may be configured to communicate with specific electronic components (or a specific number of electronic components). The operation (or configuration) of the microchip may be governed by the second computer program. Communication with the specific electronic components may be achieved by executing the second computer program to turn on the ports (e.g., serial or parallel), buses (PCI or PCIe), or other electrical connections on the motherboard to which the specific electronic components are connected. The operation of the microchip may also be governed by hardware such as by arranging a portion of the bus 150 to connect the microchip to a certain electronic components or by implementing a separate dedicated bus to create such connection. The electrical connection may also be established by the bus 150, wires, and/or circuitry on the motherboard. The operation of the microchip may also be governed by a combination of software and hardware. The operation of the microchip may be controlled and changed by the computer user via a graphical user interface described with respect to FIG. 5 below.

The processor 110 in FIG. 1 is configured to communicate with a first number of electronic components and the microchip is configured to communicate with a second number of electronic components. The first number and the second number may be the same or different. Preferably, the second number is less than the first number since in one embodiment the microchip is activated only when the computer system 100 experiences a failure and the user may only need certain electronic components in order to resolve the failure. For example, the processor 110 may be configured to communicate with all the electronic components shown in FIG. 1 since the processor 110 is responsible for controlling the operations and performance of the computer system 100. On the other hand, the microchip may be configured to communicate with the network interface 130, the I/O devices 135, and the media device 148 only, or one or more of these components only. With less connections and less operations to be performed, the microchip and the second computer program can be designed and implemented with simpler computer architecture and algorithms. Such a microchip and computer program can have a smaller physical size and program file size, respectively, demonstrate a faster response time, and consume less power compared to the processor 110 and the operating system. A failure may be a hardware failure or a software failure. A failure can mean completely inoperable (e.g., cannot be powered on if it is a hardware failure or cannot be loaded if it is a software failure) or substantially inoperable (e.g., can be powered on but cannot perform its primary function or operate like a normal working hardware device or can be loaded but cannot perform its primary function or operate like a normal working software). A hardware or software that is substantially inoperable may be one that shuts off or freezes intermittently, one that cannot be recognized by the operating system after it is powered on or loaded, and other substantially inoperable situations. A failure can also refer to a situation where the computer system cannot complete or perform one of the processes in the start-up procedure or complete or perform one of the steps in the boot process (e.g., the computer system is unbootable). The start-up procedure and the boot process are described below. A hardware failure may be a storage failure. A software failure may be an operating system failure.

FIG. 4 depicts an illustrative start-up procedure 400 carried out by a computer system having a microchip in accordance with some embodiments of the present invention. The procedure 400 includes a power-up process 405, a preliminary activation process 410, and a boot process 415. The power-up process 405 refers to the process of supplying electric energy to the computer system via the power supply (145, FIG. 1), such as pressing the power button. Upon receiving electric energy, the preliminary activation process 410 is performed. The process 410 turns on one or more electronic components (mandatory or preliminary electronic components). The mandatory electronic components may include the processor (110, FIG. 1). The non-volatile memory (120, FIG. 1) and the microchip (140, FIG. 1) may also be mandatory electronic components that are turned on during the process 410. The mandatory electronic components to be turned on may be determined by the physical wires, circuitry, bus and/or other hard wire on the motherboard. The processor 110 is configured to read and execute BIOS stored in the non-volatile memory 120 once the processor 110 is turned on. The execution of BIOS begins the boot process 415.

The boot process 415 includes initializing and testing additional electronic components 420 and loading an operating system 425. In step 420, the electronic components to be initialized and tested may be electronic components that are not yet activated in process 410. The electronic components may be initialized and tested via bus 150. Step 420 includes initializing and testing a storage (e.g., 125, FIG. 1). Upon verifying that the storage is operational, an operating system stored in the storage 125 is loaded in step 425. Upon successfully loading the operating system, the start-up procedure ends in step 430 and the user can operate the computer system 100 via the operating system to gain full functionality of the computer system and use every electronic component on the computer system, which include functionalities and electronic components that are not available from using BIOS (e.g., creating and viewing documents, downloading data from the Internet, etc.). Step 420 may be known as power-on self-test (POST). The initializing and testing step 420 is a step of preparing electronic components so that they can load the operating system and be used in the operating system environment by the user, rather than enabling BIOS to use the initialized and tested electronic components or allowing the user to use the initialized and tested electronic components in the BIOS environment. In some embodiments, the preliminary activation process 410 may be part of the boot process 420, and the preliminary activation process 410 performs before step 420.

The boot process 415 may be interrupted when the computer system experiences a failure in either step 420 or 425. BIOS is available for the user to operate the computer system when a failure occurs. BIOS may include a graphical user interface or a software to partially control (or only partially control) the operation of the computer system and diagnose the failure, such as finding what the failure is. BIOS or other firmware capable of performing a boot process used in the computer system is one that does not initialize the network interface 130 or that does not provide Internet access or other network access (e.g., local area network access, access to another computer system, etc.). Absent the microchip or with the microchip turned off, the user or the computer system gains network access through the operating system. The boot process 415 usually is the first process performed by the computer system after the computer system is powered on. The boot process 415 is the first process performed in the sense that it is the first process performed after the mandatory electronic components are turned on.

A failure 435 may occur in step 420 when an electrical component is completely or substantially inoperable (hardware failure) or the software or driver of an electrical component is corrupted or cannot be recognized by the processor (software failure). The second computer program on the microchip may be loaded by the processor (either process 110 or 210) when a failure 435 is detected. The failure 435 may be a storage (e.g., hard drive) failure such that the processor cannot read the operating system in the storage. The failure 435 may be other hardware failure that prohibits the processor from reading or executing the operating system. When the failure 435 is detected, the second computer program may be loaded (step 440) instead of the BIOS graphical user interface or other BIOS software configured to partially control (or only partially control) the operation of the computer system and diagnose the failure 435. The loading of the second computer program moves the computer system from its current software environment (BIOS) to a different software environment (second computer program) that works independent of the current software environment. The second computer program takes over the role of BIOS and BIOS may cease to proceed. In some embodiments, both the second computer program and the BIOS graphical user interface or other BIOS software can be presented to the user allowing the user to select which application the user would like to use (e.g., via MS-DOS). When the second computer program is loaded 440, the microchip initializes the electronic components that the microchip is configured to communicate with, such as the network interface (130, FIG. 1), the I/O devices (135, FIG. 1), and the media device (148, FIG. 1). Prior to loading the second computer program, such electronic components may be off or deactivated. Upon loading the second computer program, the second computer program allows the user to partially control (or only partially control) the operation of the computer system and diagnose the failure via those electronic components. In some embodiments, the second computer program may allow full operation of the computer system such as that provided by an operating system. The second computer program may include a graphical user interface. At the minimum, the second computer program allows the user or the computer system to initialize the network interface and gain network access. If no failure is detected, the step 420 proceeds to step 425.

A failure 445 may also occur in step 425 when the operating system cannot be loaded (completely inoperable) or can be loaded but fails to work normally (substantially inoperable). In either situation, the problem may be caused by virus, improper computer system configuration (e.g., through the registry in the operating system), hardware failure (e.g., storage failure), or other means that causes the operating system to be unrecognizable by the processor. In either situation, all the electronic components may be fully functional. The failure 445 may be other software failure that prohibits the processor from loading the operating system or the operating system from working satisfactorily. Failure 435 and 445 may also coexist. When the failure 445 is detected, the second computer program may be loaded (step 440) instead of the BIOS graphical user interface or other BIOS software configured to partially control (or only partially control) the operation of the computer system and diagnose the failure 445. The second computer program operates and includes functionalities as described above, which at the minimum allows the user or the computer system to initialize the network interface and gain network access. If no failure is detected, then the start-up procedure 400 ends in step 430 and the user can use the loaded operating system to access all the functions or electronic components provided by the computer system or other functions or electronic components that are unavailable in BIOS or the second computer program.

A failure 450 may also occur in the preliminary activation process 410 when one or more of the mandatory electronic components cannot be turned on or can be turned on but cannot operate because of a hardware issue or other issue. The mandatory electronic component(s) that cannot be turned on may be the processor 110, non-volatile memory 120, or both. The processor 110 and non-volatile memory 120 are electrically connected to the microchip 140 via a circuitry, wire, or bus physically built on the motherboard to communicate with each other (e.g., transmitting and receiving signal or data). When the microchip 140 detects that the processor 110 fails to turn on or turns on but cannot operate, the processor 210 in the microchip is initialized to read and execute the second computer program stored in the non-volatile memory 205. When the microchip 140 detects that BIOS or other firmware on the non-volatile memory 120 cannot be read and executed by the processor 110, the processor 210 in the microchip may also be initialized to read and execute the second computer program stored in the non-volatile memory 205. In some embodiments, the processor 110 may read and execute the second computer program stored in the non-volatile memory 205 if the processor 110 is functional, instead of the processor 210. The microchip may detect such situations by the processor 110 or non-volatile memory 120 sending an error message to the microchip in response to a failure (e.g., cannot be turned on or can be turned on but cannot operate), by receiving no signal, messages, or responses from the processor 110 or non-volatile memory 120 due to a failure, or by other methods. The processor of the microchip may perform the detection. If no failure is detected, the process 410 proceeds to the process 415.

In the power-up process 405, the power supply may fail to operate. The microchip may detect such an issue in a manner described above. The microchip is also electrically connected to the power supply via a wire, bus, or circuitry on the motherboard to communicate with each other (e.g., transmitting and receiving signal or data). When the microchip detects such a failure, e.g., cannot receive power from the power supply, the processor of the microchip is powered on or initialized by the battery in the microchip. The battery can supply electric energy to the processor. Once the processor is powered on, the processor can read and execute the second computer program. In some embodiments, the computer system's processor (110) can also be powered on or initialized by the battery when the power supply fails. The computer system's processor can then perform processes 410, 415 or read and execute the second computer program. A microchip having a battery does not need to depend on the power supply to operate. A microchip having no battery may depend on the power supply to operate and may be powered by the power supply via the electrical socket, a power wire, or a UBS connection. The battery is different from the motherboard battery (e.g., CMOS battery) that is configured to feed the configuration memory and feed the real time clock of the computer system (e.g., current date and time). The battery is one that can provide an amount of voltage, current, or power that is higher than that of the motherboard battery or that has enough voltage, current, or power to power on processor 110, 210 and/or non-volatile memory 120, 205. If no failure is detected, the process 405 proceeds to the process 410.

In general, once a failure is detected, the start-up procedure 400 is aborted at the process in which the failure is detected and the second computer program is loaded. The user stays in the environment provided by the second computer program to resolve the failure or use services provided by the second computer program. The user may use the second computer program to reinitiate the start-up procedure 400. The second computer program can also be loaded in any of the processes when no failure is detected.

To permit the computer system loading the second computer program in response to all four types of failures 435, 445, 450, 455, preferably the microchip is one that includes a processor, a non-volatile memory, and a battery. To permit the computer system loading the second computer program in response to failures 435, 445, 450, preferably the microchip is one that includes a processor and a non-volatile memory. To permit the computer system loading the second computer program in response to failures 435, 445, preferably the microchip is one that includes a non-volatile memory. The microchip may include more or less electronic components and be configured to respond to a particular type of failure or any number of types of failures.

After the second computer program is loaded 440, a graphical user interface is presented to the user. FIG. 5 depicts an illustrative graphical user interface 500 provided by the second computer program in accordance with some embodiments of the present invention. The interface 500 includes one or more commands, such as a diagnostics command 505, a virus scan command 509, a chat command 510, a share command 520, a data transfer command 525, a media device activation command 535, a video access command 537, a network access command 540, a restart command 542, a print command 543, a setting command 544, and one or more windows 545, 550 configured to display information and subcommands provided by the selected command and to interact with the user. The windows 545, 550 may be in the same window 555 that contains the commands or be separate windows generated in response to a user command selection. The interface 500 may include other commands. A command or a subcommand may be a button, an icon, a window or the like. A command or subcommand may allow the user to enter text and/or select a choice from a window displayed on the screen. Upon loading the second computer program 440, the network interface (130) is initialized and ready to be used by the computer system to establish a network connection. The network connection may also be automatically established upon initializing the network interface (without requiring user input).

In response to the user selecting the diagnostics command 505, the interface 500 may display a list of electronics components in the computer system in a window (e.g., window 545). The user may select one of the electronic components to be addressed by a diagnostic application that is part of the second computer program. The diagnostic application performs one or more tests on the selected electronic component. The tests may include determining whether the software driver for the selected electronic component is correctly installed in the computer system, determining whether the installed software driver is the most current software driver for the selected electronic component, evaluating whether the selected electronic component is operating or operating correctly, and other tests. The evaluating step may include sending an operating test instruction to the selected electronic component and receiving test response after the selected electronic component receives or executes the instruction, or sending an instruction that requires actual performance of the selected electronic component and receiving the selected electronic component's response to the instruction during or after the performance.

If a selected electronic component did not pass a diagnostic test, the diagnostic application attempts to repair the failed component. The repair attempt may include reinstalling a software driver or resetting a failed component. If the diagnostic application is unable to repair the problem, the diagnostic application may suggest recycling the software drivers for the failed component, powering off and on the failed component, or rebooting the computer system (e.g., to perform the entire procedure 400 again, to perform only processes 410 and 415, or to perform only process 415). If the attempt repair is successful, the second computer program may automatically restart the procedure 400 or the user can select the command 507 to restart the procedure 400 so the operating system can be loaded and used to gain full access to the computer system. The diagnostic application may query the user to determine whether the selected component is operating or operating correctly or to verify that the selected component has been repaired. The diagnostics command and diagnostic application interact with the window 545 to display relevant information and results. The window 545 includes commands allowing the user to interact with the displayed information and results, such as viewing and selecting the displayed information and results. The virus scan command 509 allows the user to perform a virus scan of a selected electronic component.

When the user selects the chat command 510, the command 510 may connect the user to a computer technician via the network connection established during the start-up procedure. The network connection may be based on communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The user and the computer technician can communicate with each other via a window (e.g., window 550). The computer technician is an individual who is skilled in repairing computer systems and works in a remote technical support center. The computer technician may also be in the same location as the user. The window 550 includes commands allowing the user to enter information and view information provided by the computer technician. In some embodiments, the network connection to a computer technician can be established automatically after the second computer program is loaded. The chat command 510 may also connect the user to vendors and other individuals. The chat command 510 may provide a list of repair centers, vendors, and individuals that the user wish to be connected to.

The share command 520 allows the user to share his or her computer screen with the computer technician so the user and the computer technician can view the screen simultaneously and discuss the computer system problem live via the window 550. The share command 520 also allows the computer technician to use the commands in FIG. 5 to diagnose and troubleshoot the problem. The share command 520 may also allow the computer technician to access BIOS, and the computer technician's interaction with BIOS may be displayed in the window 545. The share command 520 may also allow the computer technician to control an electronic component and access files in an electronic component. The electronic component may be one that the microchip is configured to communicate with by default or one that the microchip is not configured to communicate with by default (subsequently selected or initialized by the user via the graphical user interface). The data transfer command 525 allows the user to transfer data from a storage (whether the storage is operational or not operational) or other data generated by the second computer program (e.g., diagnostic results) or BIOS (e.g., error messages) to the computer technician via the network connection established during the start-up procedure. The data transfer command 525 allows the user to accept data sent by the computer technician. The share command 520 and the data transfer command 525 can be selected to perform their respective function without selecting the chat command 510 first. Either or both the share command 520 and the data transfer command 525 may also allow the computer technician to transmit data from his or her end to the computer system. Such transmission includes transmitting driver files for the electronic components and software files for the operating system, loading software or diagnostic application from the technician's end to be used on the computer system, loading an OS image file (e.g., a copy of the previous state of the computer system that can be used to restore the computer system to the previous state), and other transmission.

In some embodiments, the functions provided by the second computer program can be implemented on a server or a different computer system and be accessible by the computer system through the network connection established during the start-up procedure (e.g., diagnostic application, virus scan, etc.).

The media device command 535 allows the user to turn on or off a media device. A media device may be a read-only optical memory device (e.g., CD-ROM, DVD-ROM, etc.), a flash card reader, a USB port, or the like. The media device also allows the user to provide information to and store information received from the computer technician and to access additional functionalities of the computer system. The media device may be already turned on after the second computer program is loaded.

The video access command 537 allows the user to activate a video card or video port. Upon activating a video card, the user can view videos in a window (e.g., window 545). The videos may be obtained from a storage, the technician, or other sources. The video card may not be one of the default electronic components that the microchip is configured to communicate with, but access to the video card can be subsequently established by selecting the video access command 537. In some embodiments, the video card may be one of the default electronic components and be used to display the graphical user interface to the user.

The network access command 540 allows the user to turn off or on the network connection. When the user selects the command 540 to turn a network connection, a list of available connections is presented to the user. The user may select an available network to gain network access. A network connection may be a connection to an access point, a server, a computer system, or other devices (e.g., mobile device). The network connection may be automatically provided such that the computer system already has network access after the second computer program is loaded without requiring user input or selection. The network connection may be turned off by the user subsequently via the same command 540.

The restart command 542 allows the user to reinitiate the start-up procedure. The start-up procedure can be reinitiated before or after a failure is repaired. The start-up procedure is reinitiated from the power-up process. The start-up procedure may also be reinitiated from other process (410 or 420).

Upon selecting the print command 543, the second computer program can establish a communication with a printer if a printer is connected to the computer system and instruct the printer to print any information provided by the second computer program, including information displayed in windows 545, 550, diagnostic result, and other information. The printer may not be one of the default electronics components that the microchip is configured to communicate with, but access to the printer can be subsequently established by selecting the print command 543.

Upon selecting the setting command 544, the user is presented with different settings of the second computer program. The setting may include when the second computer program should be loaded (e.g., whenever a failure is detected, when a specific type of failure is detected, always be loaded even if there is no failure, or never) and the default electronic components that should be automatically internalized by the second computer program upon loading the second computer program.

The second computer program may also have its own web browser that is accessible via the graphical user interface. The web browser allows the user to search, reach, and explore information on the World Wide Web via the network connection established during the start-up procedure.

Although embodiments of the present invention are described with respect to BIOS, the above disclosure equally applies to other firmware that can perform a boot process. A firmware is a computer program that can perform a boot process as described above. An operating system is a computer program that is loaded during the boot process or at the end of the boot process. The firmware and the operating system operate in two separate environments and independent of each other. Non-volatile memory 120, 205 include a set of computer instructions or a code allowing the processor 110, 210 to read and execute BIOS or computer program stored on memory 120, 205. In some embodiments, the microchip 140 can replace the non-volatile memory 120 so the second computer program on the microchip 140 can be used as BIOS. In some embodiments, the microchip 140 and the non-volatile memory 120 can be implemented as one single component that stores two different firmware. The operation of the computer system may be controlled by the processor of the computer system, the processor of the microchip, or both processors. One processor may operate under instructions of the other processor. After successfully loading the operating system, the microchip can be powered off to save power consumption. The microchip remains off while the operating system is controlling the computer system. The microchip can be powered on again when the start-up procedure begins (in the power-up process). Network access includes Internet access or other network access (e.g., local area network access, access to another computer system, etc.). Preferably, network access refers to Internet access. Network access and network connection are synonymous and are used interchangeably throughout this disclosure. The network connection established during the start-up procedure (by the second computer program) may be available to the computer system only during the start-up procedure. Once the operating system begins to load or is loaded, the operating system relies on the network connection provided by the operating system (e.g., using the operating system to detect available network connections and to connect the computer system to an available network). The term initialize may refer to powering up an electronic component and/or activating an electronic component such that it can be recognized and used by the computer system.

The operation and interaction between BIOS and the second computer program on non-volatile memory 120, 205 are different from the operation and interaction between the two operating systems installed on one or two separate hard drives. One difference is that BIOS and the second computer program are programs permanently installed on a non-volatile memory 120, 205 and cannot be uninstalled or replaced by the user. Another difference is that BIOS or the second computer program are executed before any of the two operating systems is executed. BIOS or the second computer program may be a program required to run before an operating system can be loaded. Another difference is that the second computer program can be automatically loaded when a failure is detected and can always be loaded in the event of a computer failure or a storage failure. The two operating systems may require user input to select which operating system to load, and each operating system cannot be loaded if the storage on which the operating system is installed is damaged. BIOS or the second computer program can operate in such a situation. Other differences are evident from the above disclosure to a person with ordinary skill in the art.

The computer system of the present invention may also include a physical switch to activate the microchip without the computer system performing the boot process or the start-up procedure first. The switch may be used by the user to access the second computer program when there is a fault or when there is no fault. The switch may be used before or after pressing the power button of the computer system. As such, the user can manually activate the microchip to gain network connection and access other functionalities. In some embodiments, a software switch may be implemented in the operating system of the computer system allowing the user to switch between the operating system and the second computer program. The graphical user interface of the second computer program may also include a similar switch allowing the user to switch between the second computer program and the operating system.

It is understood that broader, narrower, or different combinations of the described features are contemplated, such that, for example features can be removed or added in a broadening or narrowing way. Applications of the technology to other fields are also contemplated.

It is also understood from the above description that the functionality and features of the systems, components, procedures, or processes of embodiments of the present invention include generating and sending signals to accomplish the actions.

Exemplary systems, components, procedures, and processes are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various procedures, processes, or methods (or sequence of device connections or operation) that are described herein are illustrative and should not be interpreted as being restrictive. Accordingly, it should be understood that although steps of various procedures, processes, or methods or connections or sequence of operations may be shown and described as being in a sequence or temporal order, but they are not necessarily limited to being carried out in any particular sequence or order. For example, the steps in such procedures, processes, or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or step unless the description explicitly describes user intervention or manual operation.

It should be understood that combinations of described features or steps are contemplated even if they are not described directly together or not in the same context.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A computer system for providing network access during a computer system failure of the computer system comprising:
a first processor and a first non-volatile memory electrically connected to the first processor, the first non-volatile memory storing a first firmware that is readable and executable by the first processor and that is implemented to perform a boot process;
a network interface configured to interface with a communications network and to be off prior to loading an operating system; and
a microchip electrically connected to the first processor, the microchip including a second non-volatile memory storing a second computer program that is readable and executable by the first processor, the second computer program is implemented to initialize the network interface and connect the computer system to the communications network via the network interface when the first processor detects a failure in the boot process.

2. The system according to claim 1, wherein the first processor reads and executes the first firmware to perform the boot process that includes initializing and testing additional electronic components and loading an operating system.

3. The system according to claim 2, wherein the first processor is configured to detect that one of the additional electronic components is experiencing a failure in the initializing and testing step.

4. The system according to claim 3, wherein the first processor is configured to read and execute the second computer program when the failure in the initializing and testing step is detected.

5. The system according to claim 4, wherein the network interface is initialized and connects the computer system to a communications network upon execution of the second computer program.

6. The system according to claim 2, wherein the first processor is configured to detect a failure in loading an operating system.

7. The system according to claim 6, wherein the first processor is configured to read and execute the second computer program when the failure in loading an operating system is detected.

8. The system according to claim 7, wherein the network interface is initialized and connects the computer system to a communications network upon execution of the second computer program.

9. The system according to claim 1, wherein the second computer program includes a graphical user interface having a command allowing a computer user to communicate with a computer technician in a remote location via the communications network.

10. The system according to claim 9, wherein the graphical user interface includes a command allowing a computer user to share screen or transfer data via the communications network.

11. The system according to claim 1, wherein the first processor reads and executes the first firmware to perform the boot process that is part of a start-up procedure, the start-up procedure further includes a power-up process and a preliminary activation process.

12. The system according to claim 11, wherein the microchip further includes a second processor.

13. The system according to claim 12, wherein the second processor is configured to detect a power supply failure in the power-up process.

14. The system according to claim 13, wherein the second processor is configured to read and execute the second computer program when the power supply failure is detected.

15. The system according to claim 12, wherein the second processor is configured to detect an electronic component failure in the preliminary activation process.

16. The system according to claim 15, wherein the second processor is configured to read and execute the second computer program when the electronic component failure is detected.

17. The system according to claim 1, wherein the failure is a hard drive failure.

18. The system according to claim 1, wherein the failure is software failure.

19. The system according to claim 1, wherein the network interface is an Ethernet adapter, a wireless network adapter, or a Bluetooth adapter.

20. A method for providing network access during a computer system failure comprising:
performing, by a first processor reading and executing a first firmware in a first non-volatile memory, a boot process;
configuring a network interface capable of interfacing with a communications network to be off prior to loading an operating system;
initializing, by the first processor reading and executing a second computer program in a second non-volatile memory, the network interface and connecting, by the initialized network interface, the computer system to the communications network when the first processor detects a failure in the boot process.
